(19) United States
(12) Patent Application Publication
(10) Pub. No.: US 2017/0357968 A1
(43) Pub. Date: Dec. 14, 2017

(54) Systems and Methods for Enabling Performance Review of Certified Authentication Services

(71) Applicant: MASTERCARD INTERNATIONAL INCORPORATED, Purchase, NY (US)

(72) Inventors: Mark B. Hey, St. Peters, MO (US); Stephanie Dickinson, Collinsville, IL (US); Paul Baker, Shipley (GB)

(21) Appl. No.: 15/179,114

(22) Filed: Jun. 10, 2016

(51) Int. Cl. G06Q 20/40; G06Q 20/20

(52) U.S. Cl. CPC G06Q 20/40; G06Q 20/20

(57) ABSTRACT

Systems and methods for use in enabling performance review of certified authentication services for use with a payment network are disclosed. One exemplary method includes identifying at least one performance metric of an authentication service. The authentication service is implemented into a payment network and certified to the payment network. The exemplary method also includes measuring the at least one performance metric of the authentication service, electronically notifying a service provider associated with the authentication service when the at least one performance metric fails to satisfy a defined threshold, and transmitting to the service provider at least one remedial action for the authentication service and at least one consequence for failure to satisfy the remedial action, whereby the payment network is configured to monitor the certified authentication service after certification of the authentication service.

### FIELD

The present disclosure generally relates to systems and methods for enabling performance review of certified authentication services, and in particular, to measuring performance metrics of the authentication services, when implemented for use with payment networks, relative to defined thresholds.

### BACKGROUND

This section provides background information related to the present disclosure which is not necessarily prior art.

Payment accounts are used by consumers to perform numerous different transactions including, for example, purchasing products from merchants, etc. When the payment accounts are provided to fund the transactions, the consumers are authenticated, often by signatures or PINs, to the merchants (or to point of sale (POS) terminals of the merchants). Other forms of authentication are also known, including, for example, authentication using biometrics, challenge questions, etc. Despite the different forms of authentication, in certain instances, unauthorized persons or entities still attempt to use the payment accounts to cause unauthorized transactions. As such, merchants to which the transactions are directed and issuers of the payment accounts are known to rely on enhanced authentication and authorization techniques to limit the number of such unauthorized transactions. The enhanced techniques, for example, generally involve additional services associated with the merchants, the issuers, and/or payment networks involved in processing/facilitating the transactions.

### DRAWINGS

The drawings described herein are for illustrative purposes only of selected embodiments and not all possible implementations, and are not intended to limit the scope of the present disclosure.

FIG. 1 illustrates an exemplary system for enabling performance review of certified authentication services, and including one or more aspects of the present disclosure;

FIG. 2 is a block diagram of an exemplary computing device, suitable for use in the system of FIG. 1; and

FIG. 3 is a flowchart of an exemplary method, which can be implemented via the system of FIG. 1, for measuring performance metrics of the certified authentication services relative to defined thresholds when implemented for use with a payment network.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Purchase transactions are known to include, or require, one or more forms of authentication when funded through payment accounts. However, as services, including authentication services (provided by payment networks or other service providers), are appended to processes of authorizing the transactions, delays associated with the additional services may negatively impact consumer purchasing experiences. The delays are often attributed, by consumers and merchants, for example, to the payment networks regardless of their actual source. As such, payment networks often employ certification procedures to certify the additional services, including authentication services, prior to permitting their implementation to help inhibit such delays.

Uniquely, the systems and methods herein permit performance review of previously certified authentication services, when implemented, and further permit advisements and remediation of issues therewith. In particular, performance metrics of such services are measured, at one or more defined intervals, and then compared to one or more defined thresholds. The service providers offering the services are then advised of the measured metrics (often, whether the thresholds are satisfied or not), and when the thresholds are not satisfied, advised of remedial actions to alter the performance of the services, and in some instances, deadlines and consequences for failure to implement the remedial actions. In this manner, even after certification, authentication services are reviewed to reduce impact of service provider caused delays, security issues, and/or acceptance issues associated with misuse or errant implementation of the authentication services.

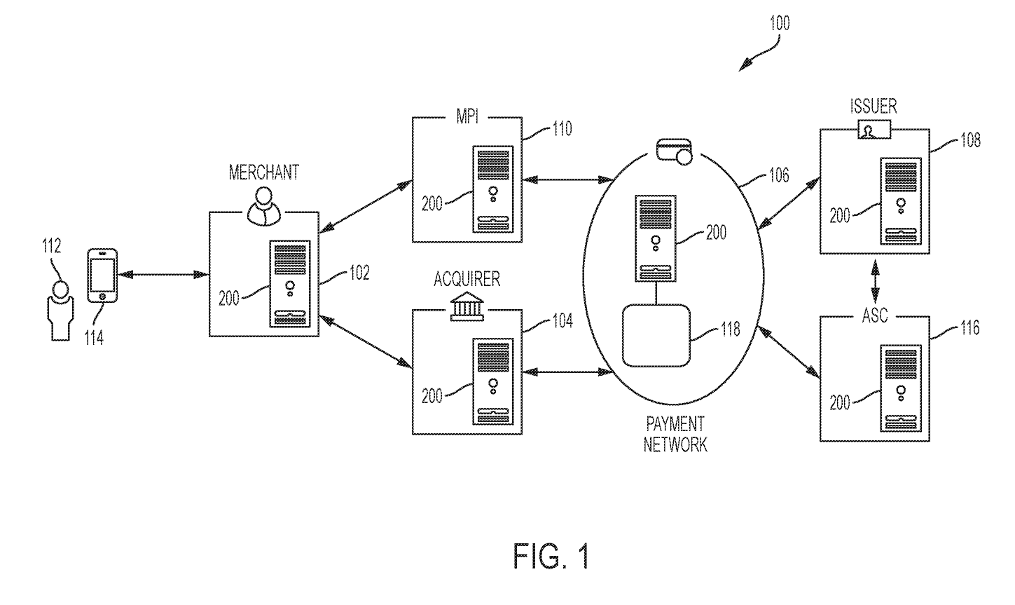

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, the manner in which consumers are authenticated, the manner in which transactions are processed, etc.

As shown in FIG. 1, the illustrated system 100 generally includes a merchant 102, an acquirer 104, a payment network 106, and an issuer 108, each coupled to one or more networks. Regardless of the arrangement of the one or more networks, or even the number of such networks in FIG. 1, network connections are generally indicated by arrowed lines between the various particular parts of the system 100. In addition, it should be appreciated that a lack of arrowed lines between different parts of the system 100 does not imply that those parts are not connected or capable of connecting via a network (the arrows may simply be omitted in FIG. 1 for ease of illustration).

The networks of the system 100 may include, without limitation, wired and/or wireless networks, local area networks (LANs), wide area networks (WANs) (e.g., the Internet, etc.), mobile networks, and/or other suitable public and/or private networks capable of supporting communication among two or more of the illustrated parts of the system 100, or any combination thereof. In one example, one of the networks includes multiple networks, where different ones of the multiple networks are accessible to different ones of the illustrated parts in FIG. 1. In particular in this example, the acquirer 104, the payment network 106, and the issuer 108 may be connected via a private network for processing purchase transactions, and the merchant 102 may be connected with the acquirer 104 (or a merchant plug-in (MPI) 110), for example, through a public network, such as the Internet.

The merchant 102 of the system 100 provides products (e.g., goods and services, etc.), at physical store-front locations (e.g., at brick-and-mortar stores, etc.) and/or through virtual store-front locations (e.g., through network-based applications/interfaces, etc.). The products are available for purchase by a consumer 112 in desired transactions. The present disclosure is described with reference to transactions in which the consumer 112 purchases products from the merchant 102 using a payment account issued to the consumer 112 by the issuer 108. However, it should be appreciated that the present disclosure encompasses a variety of other transaction scenarios, involving payments via channels other than payment accounts. In addition, the consumer 112 is associated with a communication device 114, which may be used (among other things) to facilitate network transactions (e.g., via the Internet, etc.) and/or card-not-present transactions (via a payment application containing the payment account, etc.) to purchase the products from the merchant 102 using the payment account.

In the illustrated embodiment, the consumer's payment account is associated with at least one enhanced authentication service, which requires the consumer 112 to enter codes or other identifiers known to the consumer 112 prior to conventional authorization of a transaction involving the payment account. The enhanced authentication service may include or involve, for example, one or more 3 Domain Secure (3DS) protocols such as SecureCode® by MasterCard, Verified® by VISA, Safekey® by American Express, etc.

With continued reference to FIG. 1, the system 100 includes additional parts, which participate in the enhanced authentication service associated with the consumer's payment account for certain transactions (e.g., for card-not-present transactions, etc.). In particular, the system 100 includes multiple service providers (broadly, vendors) such as the MPI 110 and an access control server (ACS) 116. As shown, each is coupled to the payment network 106, via one or more network connections (indicated by the arrowed lines). The MPI 110 and the ACS 116 may comprise any suitable computing devices and/or any protocols (e.g., including, but not limited to, 3DS protocols, etc.), for example, that take part in authenticating the consumer 112 prior to permitting/authorizing purchase transactions by the consumer 112 at the merchant 102 (and other consumers at the merchant 102 and/or at other merchants).

The MPI 110 of the system 100 is a service provider separate from the merchant 102 (in this embodiment), yet coupled thereto via one or more network connections to provide authentication messaging to/from the merchant 102, as described herein. In addition, the MPI 110 may provide services to other merchants (not shown) in the system 100. The ACS 116 is a service provider coupled to the issuer 108 via one or more network connections (and, potentially, to other issuers (not shown) in the system 100), whereby the ACS 116 provides authentication messaging on behalf of the issuer 108, as described herein. Prior to implementation of the messaging (broadly, services) by the MPI 110 and/or the ACS 116, however, the payment network 106 reviews, evaluates, tests and/or certifies the messaging services for use with the payment network 106. In the absence of the certification, the messaging services are not permitted, by the payment network 106, to participate in the enhanced authentication service.

While one MPI 110 and one ACS 116 are illustrated in the system 100 in FIG. 1, for ease of illustration, it should be appreciated that any number of MPIs and ACSs may be included in the system 100 or in other system embodiments. In addition, while the MPI 110 is illustrated as separate from the merchant 102 (and the acquirer 104), it may be incorporated with the merchant 102 and/or the acquirer 104 in other embodiments. Similarly, while the ACS 116 is illustrated as separate from the issuer 108, it may be incorporated therewith in other embodiments. Further, in at least one embodiment, the MPI 110 and/or the ACS 116, or certain aspects thereof, may be integrated with the payment network 106, or parts thereof.

An example transaction by the consumer 112 at the merchant 102 is described next, involving purchase of a product by the consumer 112 from a virtual store-front location of the merchant 102 using the consumer's payment account and the communication device 114. However, it should be appreciated that the present disclosure encompasses a variety of other transaction scenarios, involving other than payment accounts and/or involving other than communication devices.

When the consumer 112 presents credentials for the payment account to the merchant 102 for use in the purchase of the product (e.g., via the payment application at the consumer's communication device 114, etc.), the merchant 102 identifies the payment account. Because the transaction is initiated at the virtual store-front of the merchant 102, in this example, the transaction is directed to the MPI 110.

Upon receipt (or notification) of the transaction, by the merchant 102, the MPI 110 is configured to transmit an authentication message (as part of a request, for example) to the payment network 106 for the transaction, and the payment network 106 is configured to determine if the issuer 108 associated with the payment account is a participant in the enhanced authentication service described herein. In this example, the issuer 108 is a participant. As such, the payment network 106 is configured to search for the ACS 116 (e.g., an ACS address, etc.) associated with the issuer 108 and to transmit the authentication message to the ACS 116. The authentication message transmitted by the payment network 106 to the ACS 116 may include, for example, the exact message received from the MPI 110, a modified version of the message, or a new message incorporating the original authentication message in whole or in part from the MPI 110 and/or details associated therewith. The ACS 116 is configured to then verify whether or not the particular payment account associated with the consumer 112 is enrolled in the enhanced authentication service. If it is (as is the case in this example), the ACS 116 is configured to provide a response message including a verified indicator (or metric) back through the payment network 106 to the MPI 110. However, if the payment account is not enrolled, the ACS 116 is configured to provide a response message including a non-verified indicator back through the payment network 106 to the MPI 110. In either case, the response message transmitted by the payment network 106 to the MPI 110 may be the exact message received from the ACS 116, a modified version of the message, or a new message incorporating the original response message from the ACS in whole or in part and/or details associated therewith.

Upon receipt of the response message for the consumer's transaction, with the verified indicator included therein, the MPI 110 is configured to send a consumer authentication request to the virtual store-front of the merchant 102. The virtual store-front is configured to then communicate with the ACS 116 to perform authentication of the consumer 112. In particular, an interface is displayed from the ACS 116, as part of, or in a separate interface to, the virtual store-front, at communication device 114, for example, which prompts the consumer 112 to enter a code or other identifier (e.g., a biometric, etc.) particular to the consumer 112. In response to the code (or other identifier), the ACS 116 is configured to confirm the code and to generate an accountholder authentication value (AAV), which is transmitted to the MPI 110. The interface from the ACS 116 is then closed. In turn, the MPI 110 is configured to provide the AAV to the merchant 102, and in particular, to the merchant's virtual store-front. If the code (or other identifier) is not confirmed, however, the consumer 112 may be given an additional opportunity (or multiple additional opportunities) to submit the correct code (or other identifier). When the additional opportunity expires, and at discretion of the ACS 116, the merchant 102 is then prompted to decide whether to abort the transaction or submit it for authorization anyway (with certain fraud responsibility if the transaction is later determined to be fraudulent). It should be appreciated that the enhanced authentication service, described above in authenticating the consumer 112, may be different in other embodiments, but is preferably performed in addition to a conventional payment account authorization process between the consumer 112, the merchant 102, the acquirer 104, and the issuer 108.

Then in this example, based on the authentication of the consumer 112 as described above, the merchant 102 is configured to generate an authorization request in a conventional manner, to determine if the consumer's payment account is in good standing and if there is/are sufficient credit/funds to authorize the transaction. The authorization request includes, among other things, a payment account number, an amount of the transaction, and the AAV received from the enhanced authentication service. The authorization request is sent form the merchant 102 to the acquirer 104. In turn, the acquirer 104 is configured to communicate the authorization request to the issuer 108, via the payment network 106. The issuer 108 is configured to then validate the AAV, and other aspects of the authorization request to determine whether to authorize the transaction. The issuer 108 is configured to send an authorization response back through the payment network 106 to the acquirer 104, which is then provided back to the merchant 102. If the transaction is authorized, the credit line or funds associated with the payment account of the consumer 112, depending on the type of account, is decreased by the amount of the purchase, and the charge is posted to the consumer's payment account. The transaction is later cleared and settled by and between the merchant 102 and the acquirer 104 and by and between the acquirer 104 and the issuer 108 (in accordance with a settlement arrangement, etc.). Alternatively, if the transaction is declined, the merchant 102 may terminate the transaction or request alternative forms of payment.

While in the above example, the messages relating to authentication of the consumer 112 are described with reference to and are directed to and from the MPI 110 and/or the ACS 116, it should be appreciated that other messages related to a 3DS protocol, for example, or other security protocol, may be passed among the parts of the system 100, and be subjected to the methods herein.

In various exemplary embodiments, consumers (e.g., consumer 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

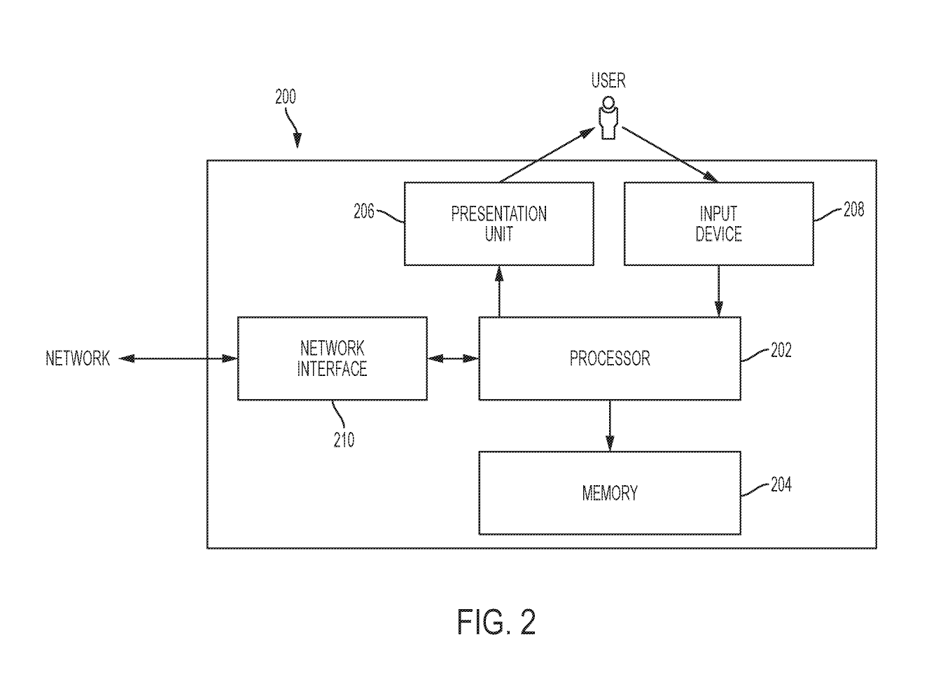

FIG. 2 illustrates an exemplary computing device 200 that can be used in the system 100. The computing device 200 may include, for example, one or more servers, workstations, personal computers, laptops, tablets, smartphones, POS terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchant 102, the acquirer 104, the payment network 106, the issuer 108, the MPI 110, and the ACS 116 are illustrated as including, or being implemented in, computing device 200. Also in the system 100, the communication device 114 associated with the consumer 112 is consistent with computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, authentication codes (or other identifiers), advisements, remedial actions, consequences, authentication outcomes, interfaces, and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and in communication with) the processor 202 (however, it should be appreciated that the computing device 200 could include output devices other than the presentation unit 206, etc.). The presentation unit 206 outputs information, either visually or audibly to a user of the computing device 200, for example, a consumer (e.g., the consumer 112, etc.), a payment network user (not shown), service provider user (not shown) or other user associated with other parts of the system 100, etc. It should be further appreciated that various interfaces (e.g., associated with authentication requests, etc.) may be displayed at computing device 200, and in particular at presentation unit 206, to display information, such as, for example, advisements, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs) such as, for example, authentication codes, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the payment network 106 of the system 100 includes a review engine 118. While the review engine 118 is illustrated as a separate component included in the payment network 106 (i.e., separate from the computing device 200 of the payment network 106), it should be appreciated that it may be incorporated in the computing device 200, which operates as described herein. Still further, the review engine 118 may be disposed elsewhere in the system 100, for example, as a standalone device, integrated with other parts of the system 100 (e.g., in one or more of the MPI 110 and/or the ACS 116, etc.), etc.

In particular in the system 100, the review engine 118 is configured to enable performance review of certified authentication services associated with, for example, the MPI 110 and/or the ACS 116 (e.g., the authentication services/messages provided in the above example transaction, etc.). In so doing, the engine 118 is configured to measure performance metrics provided by the services of the MPI 110 and/or the ACS 116. Example performance metrics are included, without limitation, in Table 1 below. In various implementations, the review engine 118 is also configured to enable performance review of authorization services herein.

TABLE 1
Performance Metric
Availability of Vendor Solution During Time
of Cardholder/Consumer Verification
Availability of Vendor Solution During Time
of Cardholder/Consumer Authentication
Overall Authentication Approval Rate of
Vendor Solution
Frequency of Required Cardholder/Consumer
Authentication for Risk Based Authentication
Frequency of Activation During Shopping
Cardholder/Consumer Authentication
Uniqueness of Generated AAV by Vendor
Solution

After measuring the desired performance metrics, the review engine 118 is configured to compare the measured performance metrics to one or more defined thresholds (or sub-thresholds). The engine 118 is also configured to provide advisements to the service providers of the system 100 (e.g., the MPI 110 or ACS 116, etc.) when the thresholds are satisfied and/or not satisfied. When not satisfied, the engine 118 is configured to include remedial actions to be taken by the service providers and one or more deadlines to perform and/or accomplish the remedial actions. In addition, the engine 118 is configured to select the remedial actions, and select and provide consequences based, in part, on the severity of deficiencies related to the thresholds and/or the type of the performance metrics at issue (e.g., critical, major, minor, etc.), etc.

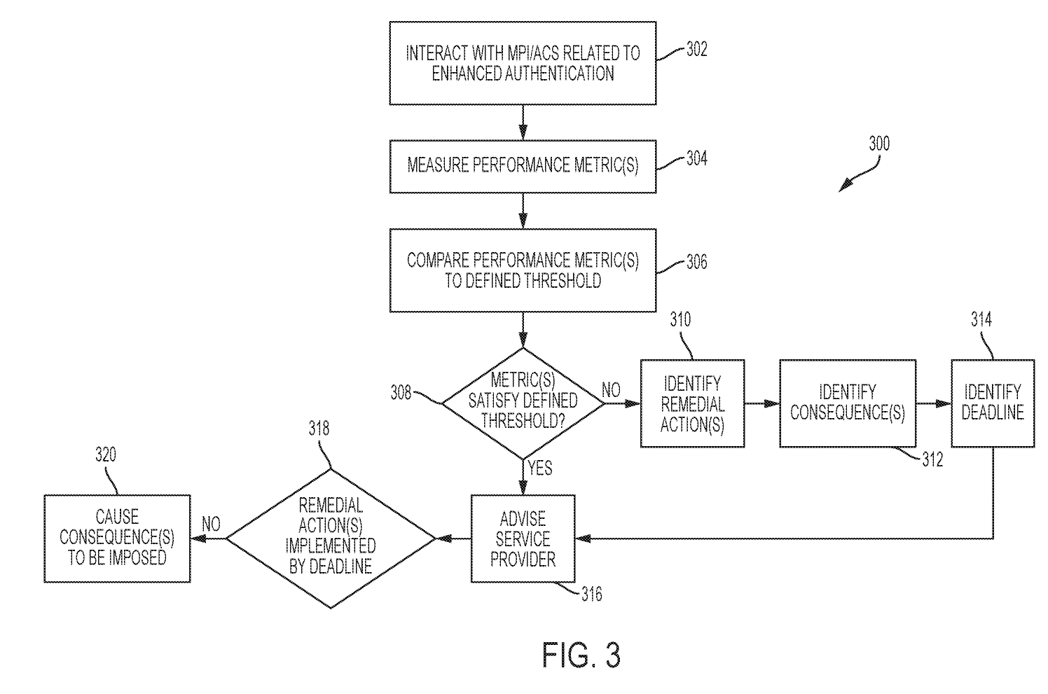

FIG. 3 illustrates an exemplary method 300 for use in measuring performance metrics of authentication services, when implemented for use with payment networks, relative to defined thresholds. The exemplary method 300 is described as implemented in the payment network 106 of the system 100 and, more particularly, in the MPI 110, the ACS 116, and the review engine 118. Further, for purposes of illustration, the exemplary method 300 is described herein with reference to other parts of the system 100 and the computing device 200. As should be understood, however, the methods herein should not be understood to be limited to the exemplary system 100 or the exemplary computing device 200, and the systems and the computing devices herein should not be understood to be limited to the exemplary method 300.

As described in the above example transaction between the merchant 102 and the consumer 112, the payment network 106 initially interacts, at 302, with the MPI 110 and/or the ACS 116, in providing enhanced authentication services for the transaction.

In connection therewith, the review engine 118 measures, at 304, one or multiple performance metrics of the messaging provided by the MPI 110 and/or the ACS 116 in association with the authentication services. As illustrated in Table 1 above, the performance metrics may include, without limitation, an availability of a vendor solution during a time of cardholder (e.g., consumer 112, etc.) verification, an availability of a vendor solution during a time of cardholder (e.g., consumer 112, etc.) authentication, an overall authentication approval rate of a vendor solution, a frequency of required cardholder (e.g., consumer 112, etc.) authentication for a risk based authentication, a frequency of activation during shopping for a cardholder (e.g., consumer 112, etc.) authentication, a frequency of activation during shopping for a cardholder (e.g., consumer 112, etc.) authentication, and a uniqueness of generated AAV by a vendor solution. The review engine 118 measures the one or multiple performance metrics at one or more defined intervals, such as, for example, hourly, every two hours, daily, monthly, etc. It should be appreciated that the defined intervals may be associated with the particular performance metric to be measured. For example the availability of a vendor solution during a time of cardholder (e.g., consumer 112, etc.) verification performance metric may be measured quarterly, while the overall authentication approval rate of a vendor solution performance metric may be measured monthly. Table 2 illustrates example intervals over which the review engine 118 may measure the example performance metrics from Table 1.

TABLE 2

| Performance Metric | Interval | Type |
|---|---|---|
| Availability of Vendor Solution During | Quarterly | Major |
| Time of Cardholder/Consumer | | |
| Verification | | |
| Availability of Vendor Solution During | Quarterly | Major |
| Time of Cardholder/Consumer | | |
| Authentication | | |
| Overall Authentication Approval Rate of | Monthly | Minor |
| Vendor Solution | | |
| Frequency of Required | Quarterly | Major |
| Cardholder/Consumer Authentication for | | |
| Risk Based Authentication | | |
| Frequency of Activation During Shopping | Quarterly | Major |
| Cardholder/Consumer Authentication | | |
| Uniqueness of Generated AAV by | Quarterly | Critical |
| Vendor Solution | | |

After measuring the performance metric, the review engine 118 next compares the measured performance metric to a defined threshold, at 306. The defined threshold is generally specific to the performance metric. For example, the defined threshold for the availability of a vendor solution during a time of cardholder (e.g., consumer 112, etc.) verification performance metric is 99%. Generally, the thresholds are defined by the payment network 106 to provide a specified level of performance from the services provided by the MPI 110 and/or the ASC 116 (and/or other service provider). The thresholds may be defined through a specification and/or through historical data related to the performance on multiple services interactions with the payment network 106, etc. Table 3 illustrates example thresholds against which the review engine 118 may compare the example performance metrics from Table 1, for example.

TABLE 3

| Performance Metric | Threshold |
|---|---|
| Availability of Vendor Solution During Time | 99% |
| of Cardholder/Consumer Verification | |
| Availability of Vendor Solution During Time | 99% |
| of Cardholder/Consumer Authentication | |
| Overall Authentication Approval Rate of | 90% |
| Vendor Solution | |
| Frequency of Required | 5% |
| Cardholder/Consumer Authentication for | |
| Risk Based Authentication | |
| Frequency of Activation During Shopping | 5% |
| Cardholder/Consumer Authentication | |
| Uniqueness of Generated AAV by Vendor | 100% |
| Solution | |

Then, at 308, the review engine 118 determines, based on the comparison, if the performance metrics satisfy the defined thresholds.

If the engine 118 determines that the performance metrics do not satisfy the defined thresholds (at 308), the review engine 118 identifies, at 310, remedial actions to be taken by the service provider (e.g., by the MPI 110 and/or the ACS 116 in the above example transaction, etc.). The remedial actions are generally predefined based on the performance metric at issue (e.g., improve the metric until it meets the predefined threshold, etc.). However, in some implementations, the review engine 118 may select/determine a particular remedial action based on the comparison (at 308) and/or the scope by which the performance metrics do not satisfy the defined thresholds, etc. In addition, the review engine 118 identifies, at 312, a consequence or multiple consequences for failure of the service provider to perform the remedial actions, and identifies, at 314, a deadline for the remedial action to be performed by the service provider. Such consequences may include, without limitation, warning letters (broadly, warnings), placing the service provider on probation, delisting the service provider from particular services, assessing a financial penalty, etc. As with the remedial actions, the consequences are generally predefined based on the performance metric at issue (but, again, this is not required in all embodiments). And, the deadlines are generally determined based on the performance metric and a type of the metric under review (and/or a finding indicated during the time of review, for example, how close the metric is to the defined threshold, etc.). For example, if the performance metric includes a uniqueness of a generated AAV by a vendor solution, and the performance metric does not satisfy the defined threshold (e.g., 100%, etc.), the service provider may be issued a warning and given thirty days to provide a resolution (e.g., modify the solution to satisfy the defined threshold, etc.). Table 4 includes exemplary deadlines for performing remedial actions for each of the example performance metrics in Table 1 (when the performance metrics are not satisfied).

TABLE 4

| | Remedial Action |
|---|---|
| Performance Metric | Deadline |
| Availability of Vendor Solution During Time of | 90 Days |
| Cardholder/Consumer Verification | |
| Availability of Vendor Solution During Time of | 90 Days |
| Cardholder/Consumer Authentication | |
| Overall Authentication Approval Rate of | Issuer Response Only |
| Vendor Solution | with Recommended |
| | Action Plan |
| Frequency of Required Cardholder/Consumer | 90 Days |
| Authentication for Risk Based Authentication | |
| Frequency of Activation During Shopping | 90 Days |
| Cardholder/Consumer Authentication | |
| Uniqueness of Generated AAV by Vendor | 30 Days |
| Solution | |

Subsequently, in connection with determining that the performance metrics do not satisfy the defined thresholds (at 308), the review engine 118 advises the service provider regarding the failure of the performance metrics to satisfy the threshold. The advisement includes the measured performance metrics, the identified remedial action(s) to be taken, the identified consequence(s), and/or the identified deadline for performance of the remedial action(s). Initial advisements may be in the form of emails, short message service (SMS) messages, voice messages, etc. Then, if the defined thresholds are not satisfied within the remedial action timelines, formal letters (e.g., subsequent advisements, etc.) may be transmitted to the offending service providers (e.g., via mail, etc.) if the metrics at issue are of either a major or a critical type (see, Table 2).

As an example, if the defined threshold for the availability of a vendor solution during a time of cardholder (e.g., consumer 112, etc.) verification, of 99%, is not satisfied (at 308), the engine 118 may initially issue a warning letter to the offending service provider (e.g., the MPI 110, the ACS 116, etc.) and provide a deadline of 90 days to rectify the metric (i.e., to take remedial action to improve the availability to 99% or greater). Then, after the 90 day deadline, if the metric is not rectified, the engine 118 may issue a probation letter to the offending service provider placing the service provider on probation with the payment network 106. As another example, if the defined threshold for the overall authentication approval rate of a vendor solution, of 90%, is not satisfied (at 308), the engine 118 may electronically notify the offending service provider (e.g., via email, network-based application, network communication, SMS message or other electronic techniques via one or more networks, etc.), and (in connection therewith) the issuer 108 may respond with a recommended action plan (or remedial action) and time frame for implementation.

Alternatively in the method 300, if the review engine 118 determines that the performance metrics do satisfy the defined threshold (at 308), the review engine 118 instead advises the service provider that the threshold has been satisfied, at 316, as well as details of the measured performance metric. The advisement, in this scenario, however, typically would not include a remedial action, a consequence, or a deadline, as no remedial action is generally required based on the measured performance metric satisfying the defined threshold. In this manner, the payment network 106 is able to inform the service provider of the performance metrics, even when the performance metrics are within the defined thresholds.

Finally in the method 300, when the advisement transmitted to the service provider regarding the measured performance metrics includes an associated remedial action, consequence, and deadline, the review engine 118 determines, at 318, if the remedial action has been performed by the deadline. If it has not, the review engine 118 causes, at 320, the consequence to be imposed. In particular, the review engine 118 may deliver the performance metrics, remedial action, consequence and deadline to an administrator associated with the payment network 106 who, in turn, reviews the advisement(s) and imposes the consequence if warranted. In the above example regarding the availability of a vendor solution during a time of cardholder (e.g., consumer 112, etc.) verification, if the defined threshold of 99% is still not satisfied (at 318) after 30 days of issuing the probation letter, a team review may occur to discuss either delisting the service provider from authentication services with the payment network 106 or assessment of a financial penalty to the service provider.

In view of the above, the systems and methods herein provide review of authentication services, implemented in payment networks, at least after certification of the services. The reviewed services, when specific to one or more of the performance metrics herein, permits the payment networks to reduce the instances of performance drop, performance degradation, and/or errant implementation and/or use, etc. of the certified authentication services, etc. In this manner, the performance of the payment network, even when provided by and/or through vendors, is confirmed and verified to be consistent with one or more desired thresholds, thereby promoting quality of service to consumers, merchants, acquirers, issuers, etc.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) identifying at least one performance metric of an authentication service, the authentication service implemented into a payment network and certified to the payment network; (b) measuring the at least one performance metric of the authentication service; (c) electronically notifying a service provider associated with the authentication service, when the at least one performance metric fails to satisfy a defined threshold; and (d) transmitting to the service provider at least one remedial action for the authentication service and at least one consequence for failure to satisfy the remedial action, whereby the payment network is configured to monitor the authentication service after certification of the authentication service.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” “coupled to,” or “in communication with” another element, it may be directly on, connected or coupled to, or in communication with the other element, or intervening elements may be present. In contrast, when an element is referred to as being “directly on,” “directly connected to,” “directly coupled to,” or “directly in communication with” another element, there may be no intervening elements present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

What is claimed is:

1. A computer-implemented method for enabling performance review of certified authentication services for use with a payment network, the method comprising:
identifying at least one performance metric of an authentication service, the authentication service implemented into a payment network and certified to the payment network;
measuring the at least one performance metric of the authentication service;
electronically notifying, by a computing device, a service provider associated with the authentication service, when the at least one performance metric fails to satisfy a defined threshold; and
transmitting to the service provider, by the computing device, at least one remedial action for the authentication service and at least one consequence for failure to satisfy the remedial action, whereby the payment network is configured to monitor the authentication service after certification of the authentication service.

2. The method of claim 1, wherein electronically notifying the service provider includes transmitting a warning to the service provider and identifying a deadline for the service provider to satisfy the remedial action.

3. The method of claim 1, further comprising electronically notifying the service provider, by the computing device, of the at least one performance metric, prior to measuring the at least one performance metric.

4. The method of claim 1, wherein the at least one performance metric includes multiple different performance metrics; and
wherein electronically notifying the service provider when the at least one performance metric fails to satisfy a defined threshold includes notifying the service provider when any one of the multiple performance metrics fails to satisfy the defined threshold.

5. The method of claim 4, wherein the defined threshold includes a defined sub-threshold for each of the multiple performance metrics.

6. The method of claim 5, wherein the multiple performance metrics include at least one of an availability of a vendor solution during a time of cardholder verification, an availability of a vendor solution during a time of cardholder authentication, an overall authentication approval rate of a vendor solution, a frequency of required cardholder authentication for a risk based authentication, a frequency of activation during shopping for a cardholder authentication, a frequency of activation during shopping for a cardholder authentication, and a uniqueness of a generated accountholder authentication value (AAV) by a vendor solution.

7. The method of claim 1, further comprising causing, by the computing device, the at least one consequence when the at least one remedial action is unsatisfied after a predetermined interval.

8. The method of claim 1, wherein the at least one performance metric includes a critical performance metric and a minor performance metric; and
wherein measuring the at least one performance metric includes measuring the critical performance metric and measuring the minor performance metric; and
further comprising identifying the at least one consequence based on whether the measured critical performance metric or the measured minor performance metric fails to satisfy the defined threshold.

9. The method of claim 1, further comprising electronically advising the service provider, by the computing device, of the measured at least one performance metric when the performance metric satisfies the defined threshold.

10. A system for enabling performance review of certified authentication services, the system comprising:
a memory comprising performance thresholds for a plurality of performance metrics associated with certified authentication services implemented for use with a payment network; and
a processor in communication with the memory, the processor configured to:
measure a performance metric of a certified authentication service;
retrieve, from the memory, a threshold for the measured performance metric and compare the measured performance metric to the threshold;
notify a service provider associated with the certified authentication service, when the performance metric fails to satisfy the threshold, of a remedial action and a deadline to satisfy the remedial action; and
implement a consequence for the service provider when the remedial action is not implemented by the deadline.

11. The system of claim 10, wherein the deadline is a first deadline; and
wherein the processor is configured, in connection with implementing a consequence for the service provider, to advise the service provider of a second deadline to satisfy the remedial action.

12. The system of claim 11, wherein the consequence is a first consequence; and
wherein the processor is configured to implement a second consequence for the service provider when the remedial action is not implemented by the second deadline.

13. The system of claim 12, wherein the second consequence includes one or more of delisting the service provider at the payment network from the certified authentication service and assessing a financial penalty to the service provider.

14. The system of claim 10, wherein the processor is configured, for each of multiple additional performance metrics of the certified authentication service, to:
measure each of the multiple additional performance metrics of the authentication service;
retrieve, from the memory, a threshold for each of the measured multiple additional performance metrics and compare each of the measured multiple additional performance metrics to its corresponding threshold;
notify a service provider associated with the certified authentication service, when at least one of the multiple additional performance metrics fails to satisfy its corresponding threshold, of another remedial action and another deadline to satisfy the another remedial action; and
implement a consequence for the service provider when said another remedial action is not implemented by said another deadline.

15. The system of claim 14, wherein the processor is configured, in connection with measuring the performance metric and in connection with measuring each of the multiple additional performance metrics, to measure the performance metric and each of the multiple additional performance metrics at a defined interval associated with the particular performance metric measured.

16. The system of claim 10, wherein the processor is configured to notify the service provider when the performance metric satisfies the threshold.

17. A non-transitory computer readable storage media comprising executable instructions for enabling performance review of certified authentication services, which, when executed by a processor, cause the processor to:
identify for review an authentication service implemented at a payment network and certified to the payment network;
measure a performance metric of the authentication service and compare the measured performance metric to a defined threshold;
notify a service provider associated with the authentication service, when the measured performance metric fails to satisfy the defined threshold, of a remedial action and a deadline to satisfy the remedial action; and
implement a consequence associated with the remedial action, for the service provider, when the remedial action is not implemented by the deadline.

18. The non-transitory computer readable storage media of claim 17, wherein the executable instructions, when executed by the processor, further cause the processor to notify the service provider of the performance metric, prior to measuring the performance metric.

19. The non-transitory computer readable storage media of claim 17, wherein the executable instructions, when executed by the processor, cause the processor to measure the performance metric of the authentication service at a first defined interval; and
wherein the executable instructions, when executed by the processor, further cause the processor to measure at least one additional performance metric of the authentication service at a second defined interval different from the first defined interval.

20. The non-transitory computer readable storage media of claim 17, wherein the deadline is a first deadline and the consequence is a first consequence; and
wherein the executable instructions, when executed by the processor, further cause the processor to:
in connection with implementing the first consequence for the service provider, to advise the service provider of a second deadline to satisfy the remedial action; and
to implement a second consequence for the service provider when the remedial action is not implemented by the second deadline.
